(19) United States
(12) Patent Application Publication
(10) Pub. No.: US 2026/0295583 A1
(43) Pub. Date: Oct. 1, 2026

(54) MICROFLUIDIC PLATFORM AND ASSOCIATED SETUP FOR MONITORING THE AGEING AND/OR DEGRADATION OF A MATERIAL OF INTEREST IN A SIMULATED MEDIUM

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); UNIVERSITE PARIS-SACLAY, Gif-Sur-Yvette (FR)

(72) Inventors: Karol RAKOTOZANDRINY, Gif-Sur-Yvette Cedex (FR); Yves BOULARD, Gif-Sur-Yvette Cedex (FR); Jean-Philippe RENAULT, Gif-Sur-Yvette Cedex (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); UNIVERSITE PARIS-SACLAY, Gif-Sur-Yvette (FR)

(21) Appl. No.: 19/480,531

(22) PCT Filed: May 17, 2024
(86) PCT No.: PCT/EP2024/063785

§ 371 Date: Oct. 31, 2025

(30) Foreign Application Priority Data
May 17, 2023 (FR) FR2304926

(51) Int. Cl. B01L 3/00

(52) U.S. Cl. CPC B01L 3/502715; B01L 3/50273; B01L 2200/027; B01L 2200/0689; B01L 2300/0663; B01L 2300/1822; B01L 2300/1872; B01L 2400/0487

(57) ABSTRACT

A microfluidic platform that monitors the ageing of a material of interest in a simulated medium, including a microfluidic chip delimited by two plates stacked one on the other and delimiting a fluid circuit including an inlet microfluidic channel, a microfluidic chamber downstream of the inlet microfluidic channel, and an outlet microfluidic channel downstream of the microfluidic chamber, a package including two blocks assembled to house the microfluidic chip, a fluidic inlet through which a fluid is intended to be injected, which is on the upstream side of the inlet microfluidic channel when the microfluidic chip is housed in the package, and a fluidic outlet by which the fluid is intended to be evacuated, which is on the downstream side of the outlet microfluidic channel when the microfluidic chip is housed in the package.

### TECHNICAL FIELD

The present invention concerns the field of monitoring the ageing and/or degradation of a material of interest in a simulated medium.

### PRIOR ART

At the design stage or when choosing a material it is important to be able to study its ageing and/or its degradation in the medium in which it is intended to be present.

Thus it is of interest to predict the functional service life of said material and to observe its impact on said medium, in particular if its degradation leads to pollution or toxic effects for the medium. For example it is important to study the ageing and the effects over time of a medication or of an implant in a human or animal body. It is equally of interest to study the pollution of the environment generated by the degradation of medications [1], plastics and metals, especially heavy metals.

Furthermore monitoring the pollution generated by potentially toxic substances is the subject of precise directives [2].

The ageing and/or the degradation of a material in a given medium is/are multifactorial. They are in particular a function of light, temperature, humidity, pH and/or interactions with the other components of the medium, for example microorganisms. Thus studies monitoring the ageing and/or the degradation of a material of interest are generally lengthy and complex and possibly necessitate many independent and varied items of equipment.

It is known to use UV, IR and/or visible light, temperature, humidity or pressure ageing chambers in order to study the degradation of a material of interest, in particular a paint, a plastic, a metal, as a function of a selected environmental parameter. These ageing chambers are generally bulky and adapted to test only one environmental variable.

There also exist methods of bringing a material of interest into contact with microorganisms, for example deposition thereof on a gel in a Petri dish. These methods can use either an oven, statically or with agitation, to monitor the temperature or a glovebox to monitor the atmosphere or a simulated day/night cycle chamber. However it is usually not possible in these cases to monitor in situ the interactions of the material of interest with the microorganisms. Furthermore these methods only enable study of the ageing and/or the degradation of a material of interest using a simplified model in which the experimental conditions remain far from those of the target medium.

Also known are mesocosms for studying the ageing or the degradation of a material of interest in a simulated medium. These are generally artificial ecosystems placed under natural environmental conditions to study the ecotoxicology of various potential contaminants of the environment. There can also be laboratory mesocosms for monitoring various parameters but they often ignore some of the environmental conditions of the target medium and do not allow sufficiently long study times. Known mesocosms are bulky and complex to use in order to achieve good monitoring of the experimental conditions.

CN2016/62570 U describes a terrestrial soil simulation device. WO2016/103152 A1 describes a device for simulation of a medium suitable for growing plants. However these devices are not suitable for simulating a plurality of varied known environments. Furthermore they are difficult to transport because of their size and weight.

Thus there exists a need for a device for monitoring the ageing or the degradation of a material of interest in a simulated medium overcoming the aforementioned drawbacks.

In particular there exists a need for a device for monitoring the ageing or the degradation of a material of interest in a simulated medium that is compact and adapted to expose the material of interest to environmental conditions and simultaneously to monitor different experimental parameters.

The object of the invention is to address at least some of these needs.

### STATEMENT OF INVENTION

To this end the invention concerns a microfluidic platform for monitoring the degradation and/or the ageing of a material of interest in a simulated medium, including:
a microfluidic chip delimited by two plates stacked one on the other and delimiting a fluid circuit including:
   an inlet microfluidic channel,
   a microfluidic chamber connected on the downstream side to the inlet microfluidic channel and including a housing for the material of interest,
   a microfluidic outlet channel connected on the downstream side to the microfluidic chamber;
a package including:
   two blocks at least one of which includes a cavity, the two blocks being assembled together to house the microfluidic chip in sealed manner,
   a fluidic inlet through which a fluid is intended to be injected and which is connected on the upstream side to the inlet microfluidic channel when the microfluidic chip is housed in the package,
   a fluidic outlet by which the fluid is intended to be evacuated and which is connected on the downstream side to the outlet microfluidic channel when the microfluidic chip is housed in the package.

Here and in the context of the invention by “material of interest” is meant a one-piece solid at least one dimension of which is greater than or equal to 1 mm.

In one embodiment the housing for the material of interest can be an imprint in a recess in one of the two plates, said recess being intended to form the microfluidic chamber.

In another embodiment the housing for the material of interest can include at least one retaining protrusion projecting into a recess in one of the plates, said recess being intended to form the microfluidic chamber. The microfluidic platform preferably includes at least one insertion guide for inserting therein the material of interest, which insertion guide opens onto one of the sides of one of the plates and into the recess facing the retaining protrusion.

The plates of the microfluidic channel are preferably made of a material transparent to ultraviolet and/or visible and/or infrared radiation, preferably made of polydimethylsiloxane or a photo-polymerized transparent resin.

The plates of the microfluidic chip preferably include one or more magnets for retaining them stacked one on the other.

The microfluidic platform preferably includes a seal arranged in the microfluidic chip around the fluid circuit.

The blocks of the package preferably include one or more magnets for holding them together.

The microfluidic platform preferably includes a seal arranged in the package around the microfluidic chip.

The microfluidic platform preferably includes at least one internal sensor housed in one of the blocks so as to face the microfluidic chamber when the microfluidic chip is housed in the package in order to measure at least one environmental parameter of the microfluidic chamber chosen from temperature, pressure, pH, gas concentration, magnetic field, relative humidity and speed of the flow in the microfluidic chamber.

The internal sensor or sensors can be a gas detector, an accelerometer, a pressure sensor, a magnetometer, a heat sensor and/or a relative humidity sensor. The accelerometer is preferably coupled to a gyroscope.

The microfluidic platform preferably includes an internal imaging system housed in one of the blocks so as to face the microfluidic chamber when the microfluidic chip is accommodated in the package in order to capture images of the material of interest in the housing of the microfluidic chamber.

The microfluidic platform preferably includes a wireless communication system connected to the internal sensor and/or to the internal imaging system in order to transmit the parameters measured by the internal sensor and/or the images captured by the internal imaging system to a receiver external to the microfluidic platform. The wireless communication system can function using Bluetooth or Wi-Fi.

The microfluidic platform preferably includes at least one external sensor configured to determine an environmental parameter of the fluid circuit on the basis of a measurement carried out outside the fluid circuit, the environmental parameter being chosen from temperature, oxidoreduction potential, in particular pH, or the presence or even the quantity of a substance in the fluid circulating in the fluid circuit.

The microfluidic platform preferably further includes a thermal regulation device for heating and/or cooling the package, preferably in the form of a Peltier module and/or a source of infrared radiation and/or a heat exchanger.

The Peltier module is preferably coupled to a metal, preferably aluminum, shell intended to be in contact with the package. The metal shell can clip around the package.

The fluidic circuit is preferably formed in at least one of the blocks of the package. The fluidic circuit preferably surrounds the cavity intended to house the microfluidic chip. This advantageously enables the heat transfer fluid to come as close as possible to the fluid circuit.

One of the plates preferably includes a viewing window through which the microfluidic chamber can be viewed when the plates are stacked and one of the blocks preferably includes a viewing port superposed on the viewing window when the microfluidic chip is housed in the package.

The window is preferably made of silicon nitride or monocrystalline quartz.

The invention also concerns an installation for monitoring the degradation and/or the ageing of a material of interest in a simulated medium, the installation including:
a platform according to the invention,
a perfusion device for injecting a fluid at a given pressure into the fluidic inlet.

The installation preferably includes a flowrate regulator connected on the downstream side to the fluidic outlet to regulate the flow of the fluid in the fluid circuit at a particular flowrate.

The installation preferably includes a fluid collector connected on the downstream side of the fluidic outlet to recover and store the effluents at the outlet of the fluid circuit.

The installation preferably includes a light source, preferably at least one LED, adapted to emit infrared and/or visible and/or ultraviolet radiation to illuminate the package.

The installation preferably includes at least one viewing device for viewing the material of interest in the housing of the microfluidic chamber.

The viewing device is preferably arranged with the viewing port in its field of view.

The viewing device is preferably chosen from a video camera, for example a CCD or CMOS video camera, a spectroscope, for example an ultraviolet spectroscope or a Raman spectroscope, and a microscope, for example a digital microscope or a scanning electron microscope.

Thus the invention essentially consists in a microfluidic platform adapted to house a material of interest in sealed manner in a microfluidic chamber of a fluid circuit the properties of which simulate a medium/environment. The material of interest can therefore be exposed to microorganisms and/or substances of the target medium under conditions closest to those of the latter and minimizing exterior influences.

The present invention can be used to monitor pollution in nature, for example in a marine or freshwater medium, generated by medications, plastics, in particular microplastics, or metals.

Furthermore it is possible to study in real time the behavior of the material of interest in the simulated medium, in particular its degradation and/or its ageing. The microfluidic platform is in particular suitable for regular sampling of data from the medium in the microfluidic chamber. In particular the integration of an internal sensor into the microfluidic platform and/or an external sensor enables collection of physical and/or chemical data from the medium in the microfluidic chamber in real time.

Likewise the installation according to the present invention includes various elements enabling observation of the behavior of the material of interest in the microfluidic chamber in real time.

The microfluidic platform according to the invention is compact and light in weight, which makes it easily transportable and suitable for varied places of use, indoors or outdoors. In particular the microfluidic platform can be of centimeter scale size when the microfluidic chip is housed in the assembled package, that is to say that its greatest dimension can be of the order of one centimeter.

The same goes for the installation according to the present invention, which is of small size compared to prior art mesocosms. In particular because of the small dimensions of the microfluidic platform the size of the installation depends mostly on the size of the perfusion device and where applicable the flowrate regulator, the fluid collector, the light source and/or the viewing device. The installation is also easily transportable because of it is modular.

Furthermore the microfluidic platform according to the invention is simple to produce and of relatively low cost.

Other advantages and features will emerge more clearly on reading the detailed description given by way of non-limiting illustration with reference to the following figures.

### BRIEF DESCRIPTION OF THE DRAWINGS

FIG. 1 is a perspective view of an installation in accordance with the present invention for monitoring the degradation and/or the ageing of a material of interest.

FIG. 2 is a perspective view of a microfluidic platform according to the invention intended to be used in an installation for monitoring the degradation and/or the ageing of a material of interest.

FIGS. 3a to 3e are perspective views of a first plate intended to constitute a part of a microfluidic chip of the microfluidic platform according to the present invention.

FIGS. 4a and 4b are perspective views of a second plate intended to constitute a part of a microfluidic chip of a microfluidic platform according to the present invention.

FIG. 5a is a perspective view of a first block of the package of a microfluidic platform according to the present invention as seen from the side of the external face of said first block.

FIG. 5b is a perspective view of the first block from FIG. 5a as seen from the side of the internal face of said first block.

FIG. 6a is a perspective view of a second block of the package of a microfluidic platform according to the present invention as seen from the side of the internal face of said second block.

FIG. 6b is a perspective view of the second block from FIG. 6a as seen from the side of the external face of said second block.

FIG. 7a is a perspective view of a syringe driver type perfusion device for an installation according to the present invention.

FIG. 7b is a perspective view of a pressure monitor type perfusion device for an installation according to the present invention.

FIG. 8 is a perspective view of an installation according to the present invention for monitoring the degradation and/or the ageing of a material of interest, the installation including a gravity type perfusion device.

### DETAILED DESCRIPTION

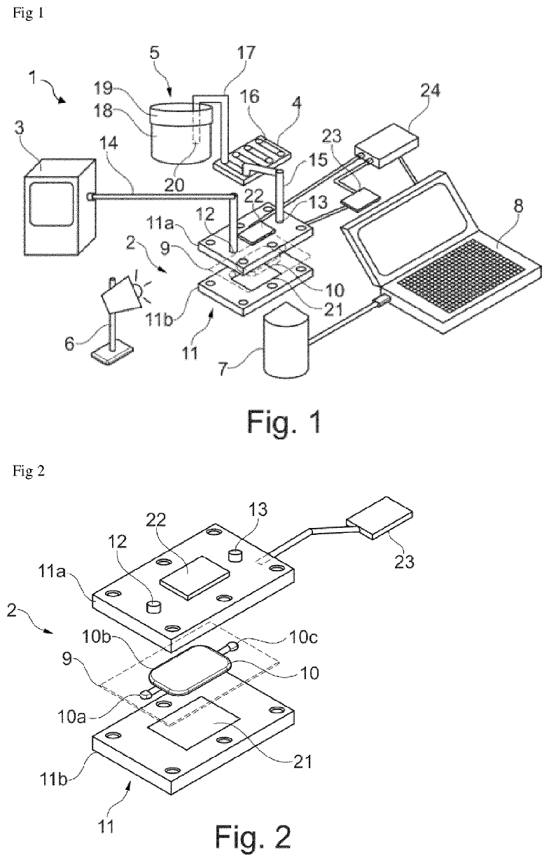

FIG. 1 depicts an installation 1 according to the invention for monitoring the degradation and/or the ageing of a material of interest.

The installation 1 includes a microfluidic platform 2, a perfusion device 3 feeding the platform 2 with fluid, a regulator 4 of the flowrate of the fluid circulating in the platform 2, a fluid collector 5 for collecting effluents from the platform 2, a light source 6 to illuminate the platform, and a device 7 for viewing the platform 2 connected to a computer 8.

The microfluidic platform 2 of the installation 1 is depicted in detail in FIG. 2. It includes a microfluidic chip 9 incorporating a fluid circuit 10 and a package 11 formed by two blocks, called the first block 11a and the second block 11b, assembled together to house the microfluidic chip 9 in sealed manner.

The fluid circuit 10 consists of an inlet microfluidic channel 10a, a microfluidic chamber 10b that houses a material of interest and an outlet microfluidic channel 10c all communicating with one another. The inlet microfluidic channel 10a is connected on the upstream side of the microfluidic chamber 10b. The outlet microfluidic channel 10c is connected on the downstream side of the microfluidic chamber 10b.

The package 11 includes a fluidic inlet 12 and a fluidic outlet 13 formed in the first block 11a. The fluidic inlet 12 is connected to the fluid circuit 10 and on the upstream side thereof when the microfluidic chip 9 is housed in sealed manner in the package 11. The fluidic outlet 13 is connected to the fluid circuit 10 and on the downstream side thereof when the microfluidic chip 9 is housed in sealed manner in the package 11.

The perfusion device 3 is connected to the fluidic inlet 12 by a feed line 14. This perfusion device 3 is configured to inject a fluid continuously into the fluid chamber 10 via the fluidic inlet 12 at a given pressure and flowrate. The fluid injected corresponds to that of the fluidic medium of interest for which the degradation and/or the ageing of the material of interest is to be monitored.

The flowrate regulator 4 is connected to the fluidic outlet 13 by an evacuation line 15. The flowrate regulator 4 is preferably passive and enables preferably manual control of the flowrate of the fluid circulating in the fluid circuit 10. The flowrate regulator 4 includes a plurality of tubes 16 of different sizes. The flowrate of the fluid in the fluid circuit 10 is therefore modified as a function of the size of the tube 16 to which the evacuation line 15 is connected. The tubes 16 are preferably produced by etching polydimethylsiloxane.

The invention therefore enables study of the ageing and/or the degradation of the material of interest in a target medium. To this end the material of interest is housed in the microfluidic chamber 10b and a fluid the properties and the constituents of which correspond to the target medium is injected by the perfusion device 3 into the fluid circuit 10 at a controlled flowrate and pressure, controlled in particular by the flowrate regulator 4.

Furthermore in order to simulate the target medium optimally the light source 6 enables control of the brightness to which the material of interest is exposed in the microfluidic chamber 10b.

The light source 6 is therefore arranged to illuminate the package 11 and the microfluidic chip 9. The package 11 and the microfluidic chip 9 are transparent to the radiation emitted by the light source 6. The light source 6 can emit infrared and/or visible and/or ultraviolet radiation. The type of radiation is chosen as a function of the medium to be simulated. Infrared radiation advantageously also enables heating of the package 11 and the microfluidic chip 9.

The light source 6 can be a lamp that is external to the package 11, as depicted in FIG. 1. The light source 6 is preferably arranged so that the angle of incidence of the radiation that it emits on the first block 11a of the package 11 is less than 45°.

Alternatively the light source 6 can be incorporated in the package 11, in particular in the second block 11b.

The installation 1 additionally includes various elements enabling information to be obtained as to the ageing and/or the degradation of the material of interest in the fluidic flow in the microfluidic chamber 10b.

To this end the installation 1 includes the fluid collector 5 to collect the effluents at the outlet of the fluid circuit 10. The fluid collector 5 is connected to the outlet of the flowrate regulator 4 by a recovery line 17. The fluid collector 5 includes at least one sterile flask 18 for storing the effluents leaving the fluid circuit 10. The flask 18 is closed by a stopper 19 pierced under sterile conditions. To collect the effluents a tube 20 previously cleaned using ethanol is inserted in the hole of the stopper 19 with one of its ends arranged in the flask 18 and the other of its ends connected to the recovery line 17. The fluid collector 5 can include a plurality of flasks 18 each closed by stopper 19 pierced in the manner described above. The flasks 18 can have different volumes.

The installation 1 also includes one or more viewing devices 7 arranged to view the material of interest in the fluid circuit 10. In particular the second block 11b includes a viewing port 21 arranged so as to be disposed over the housing of the material of interest in the fluid circuit 10. The viewing device or devices 7 is/are arranged with the viewing port 21 in its/their field of view. The viewing device or devices 7 can include a video camera, preferably a CCP or CMOS video camera, and/or a spectroscope, preferably for ultraviolet or Raman spectroscopy. The video camera can be equipped with a microscope lens.

The microfluidic platform 2 also includes at least one internal sensor 22 incorporated in the package 11 and at least one sensor 23 external to the package 11.

The internal sensor or sensors 22 is/are configured to measure at least one environmental parameter of the fluid circuit 10, in particular of the microfluidic chamber. The environmental parameter or parameters can be temperature, pressure, pH, concentration of a gas, relative humidity and/or the speed of the flow in the microfluidic chamber.

The internal sensor 22 is housed in the first block 11a so as to face the microfluidic chip 9, in particular closest to the microfluidic chamber 10b. The microfluidic platform 2 can include a plurality of different internal sensors each housed in one of the blocks 11a, 11b of the package 11.

The microfluidic platform 2 can in particular include a plurality of internal sensors 22, each of the internal sensors 22 being chosen from:
an accelerometer, for example the BHI260AP intelligent sensor from Bosch Sensortec,
a pressure sensor, for example the BMP390 digital pressure sensor from Bosch Sensortec,
a magnetometer, for example the BMM150 magnetometer from Bosch Sensortec,
a thermal sensor, for example a Pt100 temperature sensor,
a gas detector and/or a relative humidity sensor, in particular an intelligent sensor enabling simultaneous measurement of gas concentration, relative humidity, pressure and temperature under the control of an artificial intelligence, for example the BME688 intelligent sensor from Bosch Sensortec.

The microfluidic platform 2 can equally include an internal imaging system incorporated in the package 11. The internal imaging system faces the microfluidic chamber 10b and is therefore able to capture images of the material of interest in said microfluidic chamber 10b. The internal imaging system can include a video camera, for example a Nicla Vision video camera developed by Arduino Pro.

A battery can be incorporated in the package 11 to power the internal sensor or sensors and/or the internal imaging system. The sensor or sensors 23 external to the package 11 is/are configured to measure an environmental parameter of the fluid circuit 10 on the basis of a measurement taken outside the latter. For example an external sensor 23 can measure the temperature of the package 11 and from that determine the temperature in the microfluidic chamber 10b. An external sensor 23 can include a Pt100 type sensor in contact with the package 11 and/or a rH-meter, in particular a pH-meter, arranged to measure the oxidoreduction potential, where appropriate the pH, of the fluid upstream and/or downstream of the fluid circuit 10. In particular an rH-meter can include a measuring probe housed in the feed line 14 and/or in the evacuation line 15. An external sensor 23 can further include a liquid phase chromatograph and/or a spectrometer, in particular a mass spectrometer or a Fourier transform type infrared spectrometer and/or a magnetic resonance spectrometer, each adapted to identify and/or to quantify different substances in the fluid at the outlet of the fluid circuit 10.

The internal sensors 22 and the external sensor or sensors 23 are connected to a microcontroller 24, preferably of Arduino type, the microcontroller 24 being for example a Nicla Sense ME card developed by Arduino Pro. The microcontroller 24 stores information measured by and controls each of the internal sensors 22 and the external sensors 23.

Furthermore the microcontroller 24 is also connected to the computer 8 which is itself connected to the viewing device 7. The computer 8 acquires and stores data collected by the microcontroller 24 and by the viewing device 7 and transmits instructions to them. Connecting the computer 8 to the light source 6 and/or to the perfusion device 3 in order to control them can also be envisaged.

The microcontroller 24 can communicate by Bluetooth, Wi-Fi or USB with the internal sensors 22 and/or the external sensors 23 and/or with the internal imaging system and/or with the computer 8. Where applicable the microcontroller 24 is also a wireless communication system of the microfluidic platform 2.

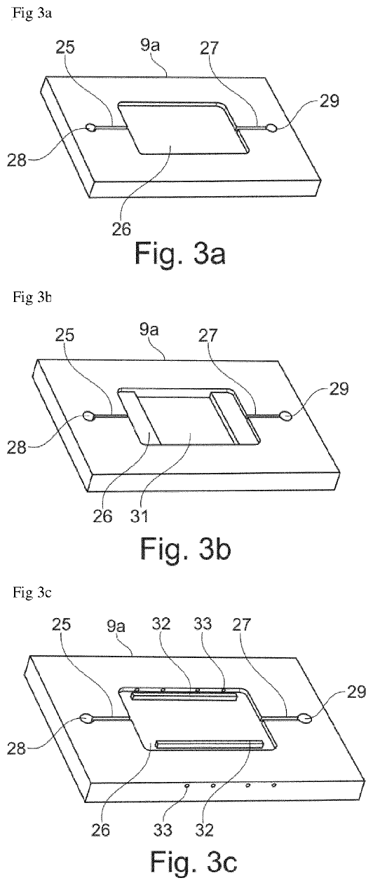

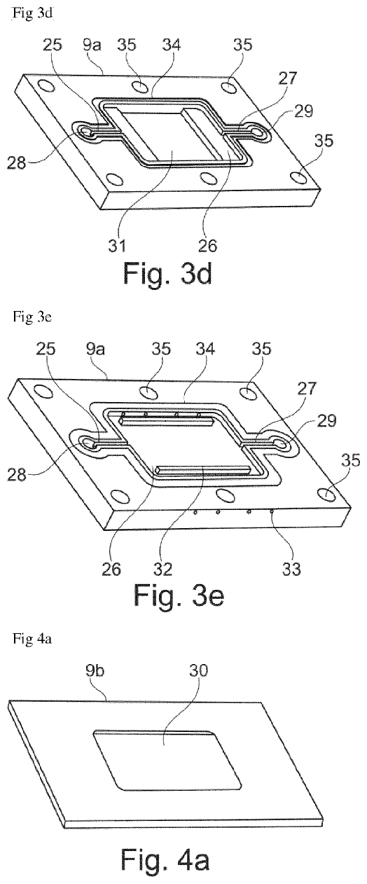

FIG. 3a depicts a first plate 9a delimiting the microfluidic chip 9. The first plate 9a is the shape of a rectangular parallelepiped of length equal to 3.5 mm and/or of width equal to 1.5 mm and/or of thickness equal to between 5 mm and 10 mm. The first plate 9a includes an injection groove 25, a recess 26 and an evacuation groove 27. One end of the injection groove 25 ends at an injection orifice 28 passing completely through the plate 9a and at the other end in the recess 26. The injection orifice 28 has a diameter of the opening between 0.5 mm and 1.5 mm. The evacuation groove 27 ends at one end in the recess 26 and at the other end at an evacuation orifice 29 passing completely through the plate 9a. The evacuation orifice 29 has an opening of diameter equal to between 0.5 mm and 1.5 mm. The injection groove 25 and the evacuation groove 27 each have a length equal to 5 mm. The sections of the injection groove 25 and the evacuation groove 27 are rectangular, preferably square, with sides of micrometer scale size, in particular less than 500 μm.

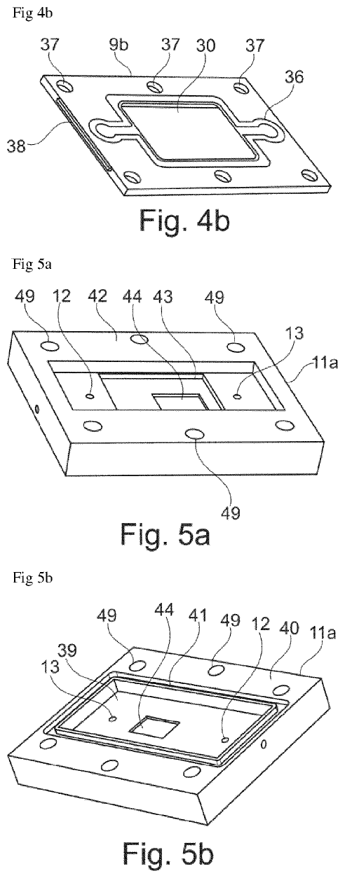

FIG. 4a depicts a second plate 9b delimiting the microfluidic chip 9. The second plate 9b is the shape of a rectangular parallelepiped of length equal to 3.5 mm and/or width equal to 1.5 mm and/or thickness equal to between 1 mm and 2.5 mm. The second plate 9b includes a glazed window 30 made of silicon nitride or monocrystalline quartz.

The microfluidic chip 9 is therefore delimited by the first plate 9a and the second plate 9b stacked one on the other. Once the stacking has been done the injection orifice 28 and the injection groove 25 form the inlet microfluidic channel 10a, the recess 26 forms the microfluidic chamber 10b, and the evacuation orifice 29 and the evacuation groove 27 form the outlet microfluidic channel 10c. Furthermore the viewing window 30 faces the microfluidic chamber 10b.

FIG. 3b depicts a first alternative plate 9a in which an imprint 31 has been produced in the recess 26. The imprint 31 therefore forms a housing for the material of interest. The shape of the imprint 31 is complementary to the shape of the material of interest. For example the imprint 31 can be the shape of a rectangular parallelepiped, in particular with a length equal to 10 mm and/or a width equal to 10 mm and/or a height equal to 1 mm.

FIG. 3c depicts a second alternative plate 9a in which two retaining protrusions 32 project into the recess 26 and including insertion guides 33. The retaining protrusions 32 are each the shape of a tongue extending in the direction of the flow of the fluid between the inlet microfluidic channel 10a and the outlet microfluidic channel 10c, that is to say parallel to the straight-line segment connecting the end of the injection groove 25 opening into the recess 26 with the end of the evacuation groove 27 opening into the recess 26. The retaining protrusions 32 form supports for the material of interest that can be housed in the microfluidic chamber formed by the recess 26 in the microfluidic chip 9.

The insertion guides 33 are ducts pierced in the thickness of the plate 9a with one end opening into the recess 26, facing one of the retaining protrusions 32, and the other end opening on one of the longitudinal sides of the plate 9a. Alternatively the insertion guides 33 can be cut-outs in the plate 9a with one end opening into the recess 26, facing one of the retaining protrusions 32, and the other end opening onto one of the longitudinal sides of the plate 9a. These insertion guides 33 are particularly suitable for insertion and retention of a material of interest in the form of a fiber. In this case the material of interest is housed in the recess 26 with one end inserted in a first insertion guide 33 and the other end inserted in a second insertion guide 33 facing the first one, the material of interest being supported over its length by the retaining protrusions 32. This embodiment suitable for materials of interest in the form of a fiber is of particular interest for studying the ageing and/or the degradation of polymers, in particular plastics, in a simulated medium.

FIGS. 3d and 3e depict a third alternative plate 9a in which there is a lip 34 and which includes magnets 35. The lip 34 surrounds the fluid circuit 10 in the microfluidic chip 9 and is intended to receive a seal. The magnets 35 are housed within the thickness of the first plate 9a.

FIG. 4b depicts a second plate 9b complementary to the first plate 9a depicted in FIGS. 3d and 3e. The second plate 9b also includes a lip 36 and magnets 37. The lip 36 is arranged facing the lip 34 of the first plate 9a. A seal can therefore be arranged in the space delimited by the lips 34 and 36 around the fluid circuit 10. The magnets 37 are housed within the thickness of the second plate 9b facing the magnets 35 of the first plate 9a. The magnets 35 and 37 therefore enable the two plates 9a and 9b to be held stacked one on the other. The magnets 35 and 37 are of cylindrical shape with a diameter between 2 mm and 3 mm and a height between 0.7 mm and 10 mm. The magnets 35 and 37 are preferably of NdFeB type, preferably with N45 magnetization. The adhesion force of the magnets 35 and 37 is between 74 g and 390 g. The magnets 35 and 37 advantageously enable simple, sealed and reversible stacking of the plates 9a and 9b one on the other. The plates 9a, 9b can therefore be separated and the microfluidic chip 9 used again.

The second plate 9b includes a notch 38 for manual handling in order to facilitate separating the second plate 9b from the first plate 9a, in particular by levering it.

Once the microfluidic chip 9 has been produced it is inserted between the first block 11a and the second block 11b of the package 11.

FIGS. 5a and 5b depict a first block 11a of the package 11. The first block 11a is the shape of a rectangular parallelepiped, for example with a length equal to 6 cm and/or a width equal to 4 cm. The first block 11a includes a cavity 39 recessed in one of its faces called the internal face 40. The cavity 39 is adapted to house a part of the microfluidic chip 9. The internal face 40 is intended to be pressed against the second block 11b. The first block 11a also includes through-holes on either side of the first block 11a opening into the cavity 39, said holes therefore forming the fluidic inlet 12 and the fluidic outlet 13. The feed line 14 can be inserted in the hole forming the fluidic inlet 12. The evacuation line 15 can be inserted in the hole forming the fluidic outlet 13. The first block 11a includes a lip 41 recessed in the internal face 40 and surrounding the cavity 39, the lip 41 being intended to house a seal called the second seal.

The first block 11a has an external face 42 opposite the internal face 40, the external face 42 being recessed to form a housing 43 intended to receive an internal sensor 22. The housing 43 includes a window 44 communicating with the cavity 39. The internal cavity 22 can be in fluidic contact with the microfluidic chip 9. In particular the microfluidic chip 9 can be permeable to gases and the internal sensor 22 can be a gas detector. Accordingly, if gases a given off during the study of the ageing and/or the degradation of the material of interest in the microfluidic chip 9 a layer of these gases given off is formed in the window 44 and the internal sensor 22 is able to identify and/or to quantify at least some of the gases present in this gas layer. For example the window 44 can be sized so that the gas layer has a thickness of 500 μm and/or a length of 8 mm and/or a width of 5 mm.

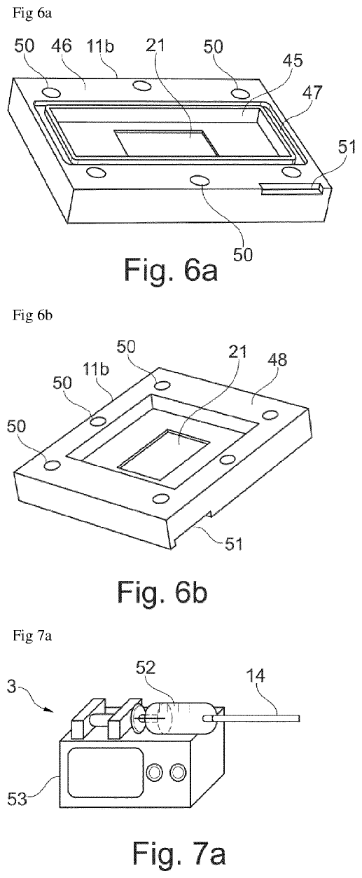

FIGS. 6a and 6b depict a second block 11b of the package 11. The second block 11b is the shape of a rectangular parallelepiped for example with a length equal to 6 cm and/or a width equal to 4 cm. The second block 11b includes a cavity 45 recessed in one of its faces called the internal face 46. The cavity 45 is adapted to house a part of the microfluidic chip 9. The internal face 46 is intended to be pressed against the first block 11a with the cavity 45 of the second block 11b facing the cavity 45 of the first block 11a in order to house the microfluidic chip 9 entirely in the space formed by disposing these cavities 39 and 45 over one another. The second block 11b includes a lip 47 recessed in the internal face 46 and surrounding the cavity 45, the lip 47 being intended to face the lip 41 of the first block 11a when the blocks 11a and 11b are assembled together. The second seal can therefore be arranged in the space formed by the lips 41 and 47 surrounding the cavities 39 and 45.

The second block 11b also includes in its external face 48 opposite the internal face 46 the viewing port 21 giving onto the cavity 45. During the study of the ageing and/or the degradation of the material of interest the microfluidic chip 9 is housed in the cavity 45 with the glazed window 30 facing the viewing port 21. It is therefore possible to observe the material of interest in the microfluidic chamber. In particular the viewing device 7 is arranged so as to be able to view the material of interest in the fluid circuit 10 through the viewing port 21 and the glazed window 30.

Alternatively the light source 6 can be incorporated in the second block 11b instead of and in place of the viewing port 21. Where applicable the viewing device 7 observes the material of interest in the microfluidic chamber 10b through the first block 11a or the second block 11b, said block then being made of a material transparent to the wavelength measured by the viewing device 7.

As depicted in FIGS. 5a and 5b magnets 49 are embedded in the first block 11a. Likewise as depicted in FIGS. 6a and 6b magnets 50 are embedded in the second block 11b. The magnets 49 and 50 hold together the assembly comprising the first block 11a and the second block 11b. The magnets 49 and 50 are of cylindrical shape with a diameter between 2 mm and 3 mm and a height between 0.7 mm and 10 mm. The magnets 49 and 50 are preferably of NdFeB type, preferably with N45 magnetization. The adhesion force of the magnets 49 and 50 is between 74 g and 390 g. The magnets 49 and 50 advantageously enable simple, sealed and reversible assembly of the first block 11a and the second block 11b. The blocks 11a, 11b can therefore be separated from one another and the package 11 used again.

The second block 11b includes a notch 51 for manual handling enabling easy separation of the second block 11b from the first block 11a, in particular by levering it.

Alternatively the first block 11a and the second block 11b can be assembled together and retained with their internal faces 40 and 46 pressed one against the other by gluing them together, in particular by oxygen plasma gluing.

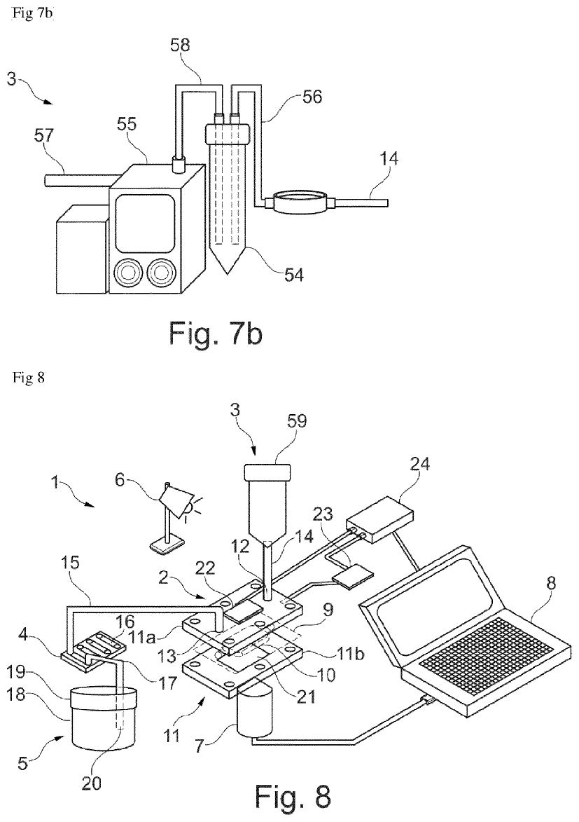

FIG. 7a depicts a syringe driver type perfusion device 3 for the installation 1. It includes a syringe 52 containing the fluid intended to circulate in the fluid circuit 10 and a perfusion pump 53. The syringe 52 is connected to the feed line 14. The perfusion pump 53 is adapted to press on the syringe 52 with at least a given pressure thereby enabling the fluid to be administered in the circuit 10 with a precise flowrate.

FIG. 7b depicts a perfusion device 3 of pressure controller type for the installation 1. It includes a tank 54 containing the fluid intended to circulate in the fluid circuit 10 and a pressure controller 55. The tank 54 is connected to the feed line 14 by a perfusion tube 56. The pressure controller 55 is connected on the downstream side to a gas inlet 57 and on the upstream side to a gas outlet 58. The gas can be compressed air or nitrogen. The pressure controller 55 is configured to inject the gas coming from the gas inlet 57 into the gas outlet 58 at a pressure set by the pressure controller 55. The gas outlet 58 is inserted in the tank 54. The pressure controller 55 can therefore modify the pressure in the tank 54 and thus inject the fluid contained in the tank 54 into the perfusion tube 56, then feeding with said fluid the feed line 14 and the fluid circuit 10.

FIG. 8 depicts a variant of the installation 1 according to the invention for monitoring the degradation and/or the ageing of a material of interest. In this variant the perfusion device 3 is of the gravity type. The perfusion device 3 includes a tank 59 arranged at a height relative to the microfluidic platform 2. The tank 59 contains the fluid intended to circulate in the circuit 10. The feed line 14 is connected to the bottom of the tank 59. The fluid contained in the tank 59 therefore flows by gravity in the feed pipe 14 and circulates in the circuit 10.

A gravity type perfusion device 3 is advantageously of simple construction, relatively compact and of relatively low cost. Furthermore it necessitates no input of energy other than the potential energy of gravity. It is therefore particularly suitable for use outside the laboratory.

The tank 59 can be a Falcon type tube, for example of 50 mL capacity, or a bottle, for example of 5 L capacity. The tank 59 is pierced at the bottom by a hole with a diameter of 1.5 mm for example. The feed line 14 is inserted in said hole and the length inserted can for example be 5 mm. The feed line 14 preferably has an outside diameter equal to the diameter of said hole. The passage of the feed line 14 in the hole is preferably sealed by depositing a glue, preferably of cyanoacrylate type.

The tank 59 can be arranged a few centimeters, for example 20 cm, above the microfluidic platform 2. To this end the tank 59 can be supported by a tank support. The feed line 14 is preferably sized so as to be tensioned between the tank 59 and the microfluidic platform 2.

The flowrate of the flow of fluid in the fluid circuit 10 is furthermore proportional to the inside diameter of the feed line 14. The inside diameter of the feed line 14 is preferably between 250 μm and 500 μm. For an inside diameter of the evacuation line 15 equal to 500 μm it is therefore possible for the flowrate regulator 4 to vary the flowrate of the flow of fluid in the fluid circuit 10 between 50 μL/min and 200 μL/min.

The tank 59 is preferably sterilized before being filled with the fluid intended to circulate in the fluid circuit 10. Sterilization can be carried out by rinsing with ethanol and/or with ultrapure water. Furthermore starting up the gravity type perfusion device 3 can include a priming step to induce the flow of the fluid from the tank 59 to the feed line 14. The priming step can include siphoning from the tank 59 via the feed line 14.

Described next is a method of producing a microfluidic platform 2 according to the invention.
Step 1: manufacture of the first plate 9a and the second plate 9b intended to constitute the microfluidic chip 9;
Step 2: manufacture of the first block 11a and the second block 11b intended to constitute the package 11;
Step 3: (optional) placing a material of interest in a recess 26 in the first plate 9a or the second plate 9b intended to form the microfluidic chamber 10b;
Step 4: stacking the first plate 9a and the second plate 9b one on the other so as to produce the microfluidic chip 9, preferably with the material of interest housed in the microfluidic chamber 10b;
Step 5: placing the microfluidic chip 9 in the cavity of the first plate 11a or the second plate 11b;
Step 6: assembling the block 11a and the second block 11b to produce the package 11 with the microfluidic chip 9 housed in sealed manner inside it.

Steps 3 and 4 can be carried out before or after step 2.

The manufacture of the first plate 9a and the second plate 9b can include a substep of molding, additive manufacture and/or micro-machining.

In accordance with a first alternative step 1 can include manufacture of molds, said molds being negative forms of the first plate 9a and the second plate 9b, followed by pouring a mixture including an elastomer into said molds, cross-linking said mixture and then removing from the molds the first plate 9a and the second plate 9b. The molds are preferably made by 3D printing, preferably by photopolymerization of a resin. Such molds are advantageously robust and simple to manipulate. The elastomer is preferably polydimethylsiloxane. The polydimethylsiloxane is advantageously transparent to daylight and permeable to gases. The poured elastomer mixture is preferably degassed and preferably includes a cross-linking agent. For example the poured mixture is a degassed mixture of polydimethylsiloxane containing a cross-linking agent with a ratio by weight of 10:1 and cross-linking is carried out in an oven at 67° C. for at least two hours.

The injection orifice 28 and the evacuation orifice 29 can be pierced after removing the first plate 9a and the second plate 9b from the molds, in particular by means of a punch.

The insertion guide or guides 33 can be produced by cutting after removal from the molds.

The production of the first plate 9a and the second plate 9b by this first alternative is simple and necessitates few substeps compared to others of the usual production methods for prior art microfluidic chips. This first alternative is particularly suitable for obtaining a first plate 9a as shown in FIGS. 3b and 3c and a second plate 9b as shown in FIG. 4a. The viewing window 30 can then be in one piece with the rest of the second plate 9b and made of polydimethylsiloxane.

In a second alternative step 1 can include 3D printing by photopolymerization of a resin, preferably a transparent resin, a first blank and a second blank, the first blank being a plate with the dimensions of the first plate 9a and including a recess 26 intended to form the microfluidic chamber 10b, an injection groove 25 opening on the upstream side of the recess 26 and an evacuation groove 27 opening on the downstream side of the recess 26, the second blank being a plate with the dimensions of the second plate 9b. The first blank can include an imprint 31 in the recess 26 or at least one retaining protrusion 32 projecting into the recess 26. The first blank can include at least one insertion guide 33 opening on the one hand onto one of the sides of the first blank and on the other hand into the recess 26 facing the retaining protrusion 32.

The first blank preferably includes a lip 34 to house a seal that surrounds the recess 26, the injection groove 25 and the evacuation groove 27. The second blank can include a lip 36 arranged to face the lip 34 of the first blank when the first and second blanks are stacked one against the other.

The first and the second blank can respectively form the first and the second plate as soon as the 3D printing is completed or the latter can be followed by one or more substeps to transform the first blank and/or the second blank into the first plate 9a, respectively the second plate 9b.

In particular 3D printing can be followed by a substep of piercing in the first blank an injection orifice 28 and an evacuation orifice 29 passing completely through the first blank and arranged so that the injection groove 25, respectively the evacuation groove 27, opens at one end onto the injection orifice 28, respectively the evacuation orifice 29.

The second blank can include an open window, 3D printing being followed by a substep of insertion of glazing in the open window so as to fill it and thereby form the closed window 30 of the second plate 9b. The second blank includes an insertion slot recessed into its thickness by means of which the glazing is inserted into the open window. The perimeter of the glazing is preferably coated with glue, preferably of cyanoacrylate type. The glue advantageously enhances the seal of the microfluidic chip 9.

3D printing can equally be followed by a micro-machining substep to produce blind holes in each of the first and second blanks followed by a substep of fixing the magnets 35 and 37 in said blind holes. The magnets 35 and 37 can be fixed by insertion and gluing in the blind holes.

Furthermore 3D printing can be followed by a substep of polishing the first and second blanks. This advantageously improves the transparency of the first and second blanks.

The production of the first plate 9a and the second plate 9b in accordance with this second alternative is particularly suitable for obtaining a first plate 9a shown in FIGS. 3d and 3e and a second plate 9b shown in FIG. 4b.

In a third alternative the first plate 9a can be produced by micro-machining the injection groove 25, the recess 26, the evacuation groove 27, the injection orifice 28 and the evacuation orifice 29 directly in the material of interest, the second plate 9b being produced by one of the methods described above. The first plate 9a is then itself the material of interest and there is no need to carry out step 3 of the method. The first plate 9a can equally not include the imprint 31 and the retaining protrusions 32. The first plate 9a is preferably similar to the first plate depicted in FIG. 3a. The micro-machining can be carried out by micro-milling or by laser cutting, preferably by CO₂ laser cutting.

The step 2 of producing the first block 11a and the second block 11b is preferably carried out by 3D printing, preferably by photopolymerization of a resin, preferably a transparent resin. 3D printing can be followed by polishing the first block 11a and the second block 11b. This advantageously enhances their transparency. 3D printing can equally be followed by integration of the magnets 49 and 50 in the first block 11a and the second block 11b. The magnets 49 and 50 can be integrated by inserting and/or gluing them in dedicated blind holes.

Step 3 of placing the material of interest can include gluing the material of interest into the imprint 31. Gluing preferably includes depositing a non-cross-linked elastomer, preferably polydimethylsiloxane, on the bottom of the imprint 31, followed by inserting the material of interest into the imprint in contact with the elastomer, followed by cross-linking the elastomer. The cross-linking can be carried out in an oven, for example at 67° C. for at least one hour.

Step 3 of placing a material of interest in the form of a fiber in the recess 26 is alternatively carried out by causing said material of interest to slide in one of the insertion guides 33. The material of interest can previously be coated with ethanol in order to facilitate sliding it along the insertion guide. Once the material of interest is housed in the recess 26 the insertion guides 33 can be filled, in particular with the same material as the plate 9a. This advantageously guarantees a good seal of the microfluidic chamber during the study of the ageing and/or the degradation of the material of interest. The filling can include cross-linking an elastomer, preferably polydimethylsiloxane. The cross-linking can be carried out in an oven, for example at 67° C. for at least one hour.

Step 4 of stacking the first plate 9a and the second plate 9b can include placing a seal between them so as to surround the fluid circuit 10 in the microfluidic chip 9. The seal can be a commercially available O-ring. Alternatively the seal can be manufactured by cutting, preferably laser cutting, a plate comprising a substrate on which a layer of elastomer has been deposited and then cross-linked, the cutting being followed by separation of the substrate and the elastomer, the cut elastomer forming the first seal. The substrate is preferably polymethylmethacrylate. The elastomer is preferably polydimethylsiloxane.

Step 4 of stacking the first plate 9a and the second plate 9b can include gluing them to one another. The gluing is preferably oxygen plasma gluing. Such gluing enhances the seal of the fluid circuit 10 and the mechanical strength of the microfluidic chip 9.

Step 5 and/or step 6 can be preceded by a step of fitting the internal sensor or sensors 22 and/or fitting a seal in the first block 11a and/or the second block 11b. This seal between the blocks 11a, 11b can be a standard O-ring.

Other alternatives and improvements can be envisaged without departing from the scope of the invention.

### LIST OF THE REFERENCES CITED

Sheree A. Pagsuyoin et al.: “Effects of sewer biofilm on the degradation of drugs in sewage: A microcosm study”, Journal of Hazardous Materials, Vol. 424, Part D, 2022, 127666.
EPA, Ecological Effects Test Guidelines OPPTS 850.1900 Generic Freshwater Microcosm Test, Laboratory.

1. A microfluidic platform for monitoring the degradation and/or the ageing of a material of interest in a simulated medium, including:
a microfluidic chip delimited by two plates stacked one on the other and delimiting a fluid circuit including:
an inlet microfluidic channel,
a microfluidic chamber connected on the downstream side to the inlet microfluidic channel and including a housing for the material of interest,
a microfluidic outlet channel connected on the downstream side to the microfluidic chamber;
a package including:
two blocks at least one of which includes a cavity the two blocks being assembled together to house the microfluidic chip in sealed manner,
a fluidic inlet through which a fluid is intended to be injected and which is connected on the upstream side to the inlet microfluidic channel when the microfluidic chip is housed in the package,
a fluidic outlet by which the fluid is intended to be evacuated and which is connected on the downstream side to the outlet microfluidic channel when the microfluidic chip is housed in the package.

2. The platform as claimed in claim 1, the housing for the material of interest being an imprint in a recess in one of the two plates, said recess being intended to form the microfluidic chamber.

3. The platform as claimed in claim 1, the housing for the material of interest including at least one retaining protrusion projecting into a recess in one of the plates, said recess being intended to form the microfluidic chamber.

4. The platform as claimed in claim 3 including at least one insertion guide for inserting therein the material of interest, which insertion guide opens onto one of the sides of one of the plates and into the recess facing the retaining protrusion.

5. The platform as claimed in claim 1, the plates of the microfluidic channel being made of a material transparent to ultraviolet and/or visible and/or infrared radiation, preferably made of polydimethylsiloxane or a photo-polymerized transparent resin.

6. The platform as claimed in claim 1, the plates of the microfluidic chip including one or more magnets for retaining them stacked one on the other.

7. The platform as claimed in claim 1 including a seal arranged in the microfluidic chip around the fluid circuit.

8. The platform as claimed in claim 1, the blocks of the package including one or more magnets for holding them together.

9. The platform as claimed in claim 1 including a seal arranged in the package around the microfluidic chip.

10. The platform as claimed in claim 1 including at least one internal sensor housed in one of the blocks so as to face the microfluidic chamber when the microfluidic chip is housed in the package in order to measure at least one environmental parameter of the microfluidic chamber chosen from temperature, pressure, pH, gas concentration, magnetic field, relative humidity and speed of the flow in the microfluidic chamber.

11. The platform as claimed in claim 1 including at least one external sensor configured to determine an environmental parameter of the fluid circuit on the basis of a measurement carried out outside the fluid circuit, the environmental parameter being chosen from temperature, oxidoreduction potential, in particular pH, or the presence or even the quantity of a substance in the fluid circulating in the fluid circuit.

12. The platform as claimed in claim 1 further including a thermal regulation device for heating and/or cooling the package, preferably in the form of a Peltier module and/or a source of infrared radiation and/or a heat exchanger.

13. The platform as claimed in claim 1, one of the plates including a viewing window through which the microfluidic chamber can be viewed when the plates are stacked and one of the blocks including a viewing port superposed on the viewing window when the microfluidic chip is housed in the package.

14. An installation for monitoring the degradation and/or the ageing of a material of interest in a simulated medium, the installation including:
a platform as claimed in claim 1,
a perfusion device for injecting a fluid at a given pressure into the fluidic inlet.

15. The installation as claimed in claim 14 including a flowrate regulator connected on the downstream side to the fluidic outlet to regulate the flow of the fluid in the fluid circuit at a particular flowrate.

16. The installation as claimed in claim 14 including a fluid collector connected on the downstream side of the fluidic outlet to recover and store the effluents at the outlet of the fluid circuit.

17. The installation as claimed in claim 14 including a light source, preferably at least one LED, adapted to emit infrared and/or visible and/or ultraviolet radiation to illuminate the package.

18. The installation as claimed in claim 14 including at least one viewing device for viewing the material of interest in the housing of the microfluidic chamber,
wherein one of the plates includes a viewing window through which the microfluidic chamber can be viewed when the plates are stacked,
wherein one of the blocks includes a viewing port superposed on the viewing window when the microfluidic chip is housed in the package, and
the viewing device is arranged with the viewing port in its field of view.
